(19) United States
(12) Patent Application Publication
(10) Pub. No.: US 2014/0038516 A1
(43) Pub. Date: Feb. 6, 2014

(54) ANTENNA STRUCTURES FOR NEAR FIELD COMMUNICATIONS

(71) Applicant: Antony L. McFarthing, Ely Cambridgeshire (GB)

(72) Inventor: Antony L. McFarthing, Ely Cambridgeshire (GB)

(73) Assignee: Cambridge Silicon Radio Limited, Cambridge (GB)

(21) Appl. No.: 13/563,979

(22) Filed: Aug. 1, 2012

(51) Int. Cl. H04B 5/00

(52) U.S. Cl. 455/41.1

(57) ABSTRACT

Nesting an active NFC coil with an open-circuited coil can boost the effective range over which the NFC coil can communicate.

### FIELD

The invention relates to wireless communication using near field communication (NFC) techniques.

### BACKGROUND

NFC is a form of wireless communication in which a communications channel is formed by creating a magnetic coupling between an antenna structure in a transmitting device and an antenna structure in a receiving device. Typically, the antenna structures of the transmitting and receiving devices need to be closer than about 40 cm in order for the magnetic coupling to be strong enough to support communications at a data rate that is sufficiently high to be considered worthwhile.

The performance of an NFC antenna is in part determined by its size. That is to say, the larger the antenna, the better NFC performance becomes. NFC antennas are often constrained to fit within the form factor of a cell phone. Due to that requirement, the largest practical NFC antenna is about credit card sized and the smallest is about one quarter of that size. That range translates to an antenna structure having an area in the range 4600 to 1100 mm². It is normal to describe NFC antennas in terms of their area since they are usually, but not always, two dimensional structures.

FIG. 1 shows the effect that antenna size has on NFC performance. FIG. 1 plots magnetic coupling strength (k) between a transmitting NFC antenna and a receiving NFC antenna as a function of the separation of the transmitting and receiving antennas. For an NFC link to be considered viable, the lower limit on the magnetic coupling strength is about 10⁻². All of the plots in FIG. 1 relate to arrangements in which the transmit and receive antennas are flat, planar, rectangular coils located in parallel planes with the centres of the coils lying on a common axis. Therefore, “antenna separation” in FIG. 1, which is the parameter assigned to the chart's horizontal axis, is the separation of the coils' centres along that common axis. In FIG. 1:
plots 76 and 74 show, respectively, the experimentally measured and theoretically predicted variation in magnetic coupling strength versus antenna separation for the case where both of the transmit and receive antennas are A4 sized;
plots 80 and 78 show, respectively, the experimentally measured and theoretically predicted variation in magnetic coupling strength versus antenna separation for the case where one of the transmit and receive antennas is A4 sized and the other is credit card sized; and
plots 84 and 82 show, respectively, the experimentally measured and theoretically predicted variation in magnetic coupling strength versus antenna separation for the case where both of the transmit and receive antennas are credit card sized.

The plots 74 to 84 do indeed show that a larger antenna size generally leads to increased NFC performance. By “A4 size”, an antenna taking up the two dimensional area of a piece of A4 paper (so approximately 62000 mm²) is meant.

It has been suggested that incorporating ferrite into an NFC antenna structure allows the size of the antenna structure to be decreased while maintaining performance. However, such an advantage would be accompanied by a disadvantage in that the cost of the bill of materials for the antenna structure will increase.

### SUMMARY

According to one aspect, an embodiment of the invention provides a wireless communications device comprising an antenna comprising a first coil that is open-circuited and a second coil, wherein one of the first and second coils is nested inside the other one of the first and second coils and wherein the device further comprises at least one of a demodulator coupled to the second coil and arranged to demodulate data from NFC signals picked up by the second coil and a modulator coupled to the second coil and arranged to modulate data onto NFC signals and then supply said signals for the second coil to transmit.

### BRIEF DESCRIPTION OF THE FIGURES

By way of example only, certain embodiments of the invention will now be described with reference to the accompanying drawings, in which:

FIG. 1 is a chart plotting magnetic coupling strength versus antenna separation for various pairings of receive and transmit antennas forming an NFC link;

FIG. 2 is a block diagram of an NFC transceiver and its NFC subsystem;

FIG. 3 illustrates schematically the antenna structure of the NFC transceiver of FIG. 2;

FIG. 4 is a cross sectional view along line C-C in FIG. 3, viewed in the direction of arrows D;

FIG. 5 is another chart plotting magnetic coupling strength versus antenna separation for various pairings of receive and transmit antennas forming an NFC link;

FIG. 6 illustrates a cross section on line A-A in FIG. 3, viewed in the direction of arrows B,

FIG. 7 is a cross sectional view along line A-A, viewed in the direction of arrows B, in a variant of the antenna structure of FIG. 3;

FIG. 8 is a repeat of FIG. 7 that has been relabelled to emphasise another feature of the geometry of the elements shown in the Figure;

FIG. 9 is a cross sectional view along line C-C, viewed in the direction of arrows D, in a variant of the antenna structure of FIG. 3; and

FIG. 10 is a schematic illustration of an alternative to the antenna structure of FIG. 3;

### DETAILED DESCRIPTION

Some of the drawings in the document describe variants of earlier drawings in the document. Where that is the case, elements carried over from one drawing to another retain the same reference signs.

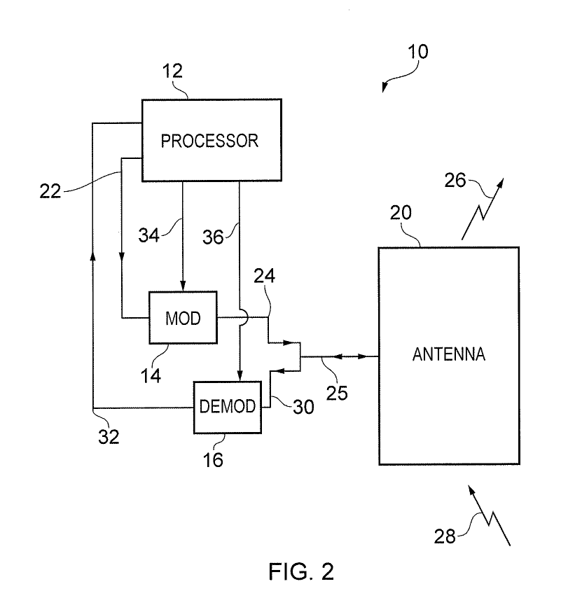

FIG. 2 is a block diagram schematically illustrating an NFC transceiver 10. FIG. 2 illustrates only those components of the NFC transceiver 10 that are most closely concerned with providing a detailed description of an embodiment of the invention. Persons skilled in the art of wireless communication device design will readily appreciate that a communications device includes many elements besides those shown in FIG. 2. As shown in FIG. 2, the NFC transceiver 10 comprises a processor 12, a modulator 14, a demodulator 16, and an antenna structure 20.

When NFC transmission from the antenna structure 20 is required, the processor 12 sends an electrical signal conveying data that needs to be transmitted over connection 22 to the modulator 14. The modulator 14 converts the electrical signal that it receives on connection 22 into a transmittable form and supplies the converted electrical signal via connection 25 to the antenna structure 20 for transmission from the NFC transceiver 10 as a transmitted NFC signal 26.

The NFC transceiver 10 can also use the antenna structure 20 to receive NFC signals, such as signal 28, that are transmitted to the NFC transceiver 10. NFC signals that are received by the antenna structure 20 are delivered over connections 25 and 30 to the demodulator 16. The demodulator 16 recovers data that may be contained in the signals received over connection 30 and sends that data as an electrical signal over connection 32 to the processor 12 so that the processor can make use of that data.

The processor 12 is further connected to the modulator 14, the demodulator 16 by means of connections 34 and 36, respectively. The connections 34 and 36 are for delivering control signals from the processor 12 that control the operation of the modulator 14, the demodulator 16 respectively. The details of the control exerted by the processor 12 on the modulator 14, the demodulator 16 and the switch 18, and the details of the modulation and demodulation schemes applied respectively by the modulator 14 and the demodulator 16, are beyond the scope of this document and in any event are conventional and tangential as regards describing the invention is concerned.

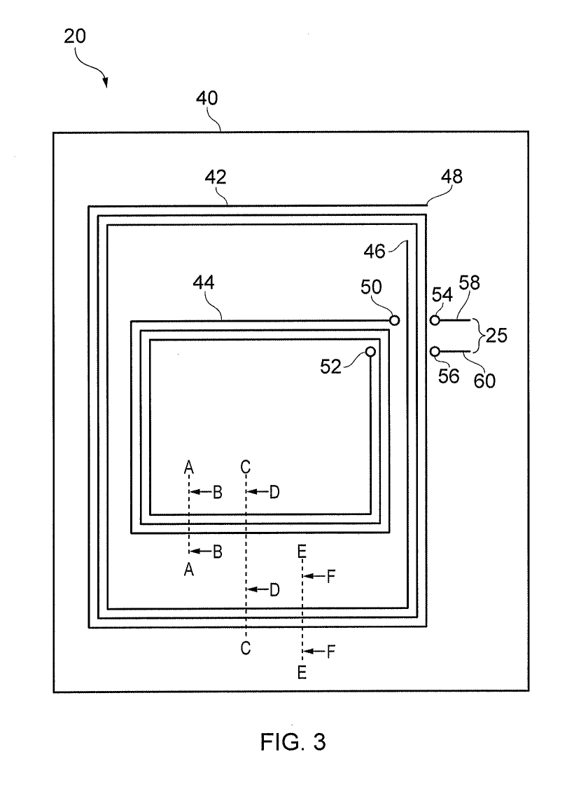

FIG. 3 shows the antenna structure 20 in more detail. As shown in FIG. 2, the antenna structure comprises a substrate 40 on which two coils 42 and 44 are provided. The substrate 40 may be, for example, a flexible plastic membrane or a printed circuit board (PCB). The substrate 40 might also support other elements of the NFC transceiver 10, for example antenna matching components. The coils 42 and 44 are each shown as rectangular coils, each having three turns. In practice, the coils 42 and 44 might have a shape other than a rectangle and could easily have a different number, typically a higher number, of turns. The coils 42 and 44 are each made of a rectangular spiral of conductive material, typically a metal. Typically the two spirals making up the coils 42 and 44 are printed or etched onto the substrate 40. The coil 44 is nested within the coil 42. In the configuration shown, coils 42 and 44 have a common centre. However, in practice, the centres of coils 42 and 44 could be offset relative to one another. The coils 42 and 44 are nested in the sense that coil 44 is enclosed by coil 42.

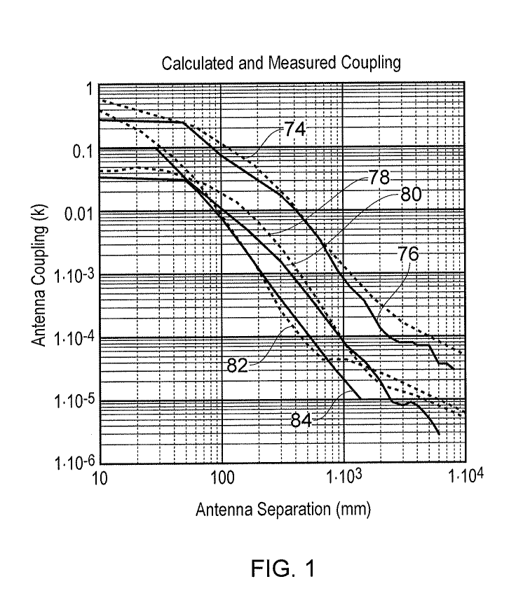

Coil 42 is an open circuited coil. That is to say, the two ends 46 and 48 of the rectangular spiral track that makes up coil 42 are not connected to anything. On the other hand, the ends 58 and 60 of coil 44 provide the connection 25 of FIG. 1 so that the coil 44 can be driven by modulator 14 and so that demodulator 16 can recover data from wireless signals that are picked up by coil 44. In order to bridge the turns of coil 42, end 58 is connected to the outer turn of coil 44 through vias 50 and 54 and end 60 is connected to the inner turn of coil 44 through vias 52 and 56.

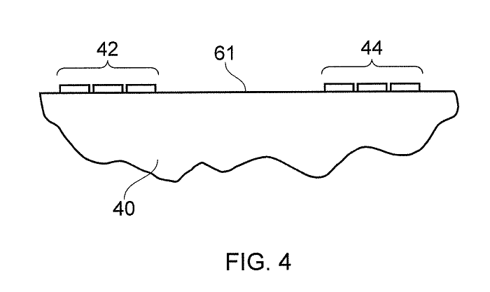

The surface of the substrate 40 that supports the coils 42 and 44 is planar such that the coils 42 and 44 are flat. FIG. 4 is a cross sectional view along line C-C in the direction of arrows D. The flat, planar, supporting surface 61 of the substrate is readily apparent in FIG. 4, as is the coplanar relationship of the turns of the two coils 42 and 44.

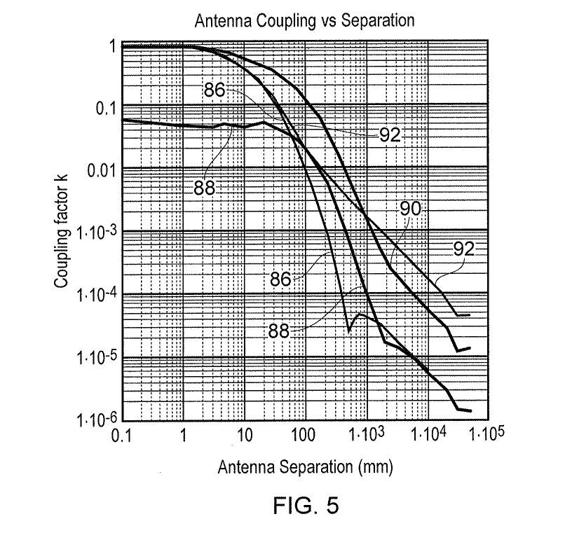

By nesting the connected coil 44 within the open-circuited coil 42, an improvement in antenna performance is achieved, in that the strength of the magnetic coupling formed with a cooperating antenna is boosted at larger distances. This effect is illustrated in FIG. 5, which plots magnetic coupling strength (k) between a transmitting NFC antenna and a receiving NFC antenna as a function of the separation of the transmitting and receiving antennas. The plots in FIG. 5 relate to arrangements in which the transmit and receive antennas are flat, planar, rectangular structures located in parallel planes with the centres of their rectangular structures lying on a common axis. Therefore, “antenna separation” in FIG. 5, which is the parameter assigned to the chart's horizontal axis, is the separation of the rectangular structures' centres along that common axis. Because the magnetic field around these antennas is toroidal in shape, and therefore not sharply directional, the curves would have similar shapes to those of FIG. 5 if measured off-axis.

In FIG. 5:
plot 86 shows the variation of magnetic coupling strength versus antenna separation for the case where both the transmit and receive antennas are credit card sized rectangular coils;
plot 88 shows the variation of magnetic coupling strength versus antenna separation for the case where one of the transmit and receive antennas is a credit card sized rectangular coil and the other one is an A4 sized rectangular coil;
plot 90 shows the variation of magnetic coupling strength versus antenna separation for the case where both the transmit and receive antennas are A4 sized rectangular coils; and
plot 92 shows the variation of magnetic coupling strength versus antenna separation for the case where one of the transmit and receive antennas is a credit card sized rectangular coil and the other one is a structure of the kind shown in FIG. 3 in which the area bounded by the outer open-circuited coil is credit card sized.

From an inspection of FIG. 5, it will be apparent that, upwards of an antenna separation of about 1000 mm, the nested coil arrangement of plot 92 is the best performing of all, and that, upwards of about 100 mm, the nested coil arrangement of plot 92 is better performing than the credit card size to credit card size arrangement of plot 86 and the credit card size to A4 size arrangement of plot 88. For conventional NFC, this extra level of coupling will probably not be too beneficial as normal NFC operation requires a coupling >10⁻² for reasonable power transfer. Other magnetically coupled systems such as NFC Peer to Peer mode and NULEF where communication occurs between two active units will benefit greatly from this new arrangement due to increased range.

Some variations of the embodiment described above will now be discussed.

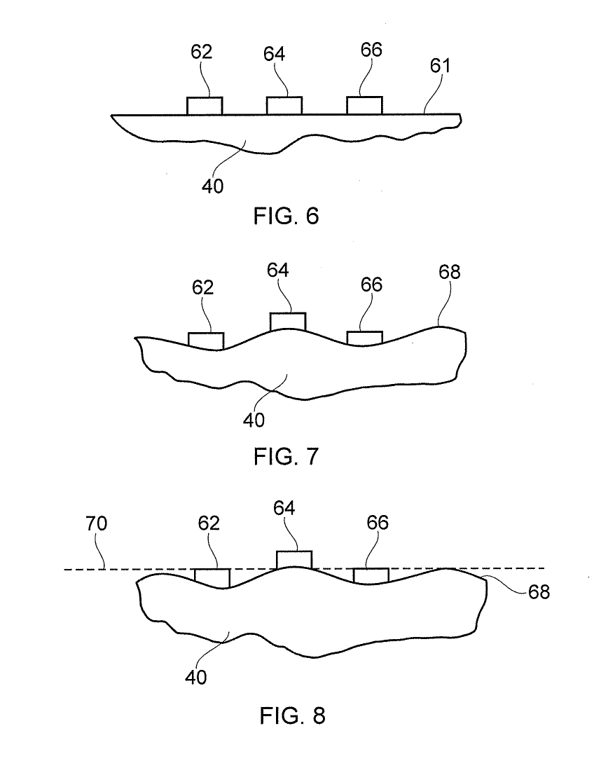

It was indicated earlier that the supporting surface 61 for coils 42 and 44 is planar. However, this need not be the case in all embodiments. FIG. 6, shows a cross section along line A-A in FIG. 3, viewed in the direction of arrows B, and reiterates that the surface 61 is flat. The turns of coil 44 are indicated 62, 64 and 66 in FIG. 6. FIG. 7 shows how the same cross section looks according to another embodiment. In FIG. 7, the surface 68 of the substrate 40 is not flat, and in this example undulates sinusoidally. In FIG. 7, the coil 44 is not flat, since the two outer turns 62 and 66 lie in minima on the surface whilst the inner turn 64 runs along a local maxima. Thus, the turns of a coil need not be coplanar.

Whilst the coil 44 has been described as having a profile that follows a surface, the surface that the turns of the coil follow need not be a physical surface. In fact, it is only convenient to talk in terms of a physical surface because in the embodiments of FIGS. 6 and 7 the turns lie on a substrate. It is, however, possible instead to refer to the turns of the coil or the profile of the coil as following a notional surface. As an illustration of this, FIG. 8 repeats the cross sectional view of FIG. 7 and adds a dashed line defining a notional surface 70 which is a plane on which the turns of the coil 44 lie, albeit that not all of the turns lie on the same side of the notional surface 70. It is indeed possible to go further, and think of the turns of the coil as defining the notional surface 70.

The foregoing discussion of the turns of a coil following or defining a non-flat surface focused on the turns of coil 44. For the sake of completeness, it is observed that FIGS. 6 to 8 and the associated discussion could equally will have related to a cross section along line E-E in FIG. 3, i.e. to the profile of coil 42. In other words, any part of either or both of the coils 42 and 44 could be locally non-planar. Moreover, although the example of a sinusoidally undulating surface was given above, the coils 42 and 44 could follow or define almost any other type of non flat surface, for example a parabolic or otherwise dished surface.

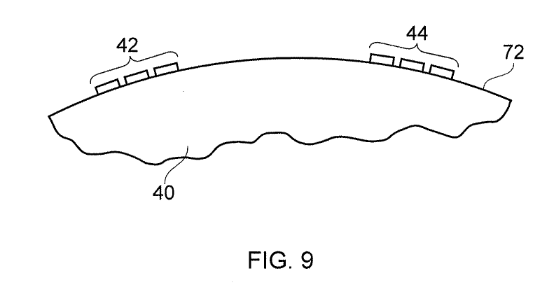

The coils 42 and 44 need not be coplanar. In the embodiment of FIGS. 3 and 4, the surface 61 of the substrate 40 is planar. However, that need not necessarily be the case. FIG. 9 relates to an example where the surface 72 of the substrate 40 is crowned rather than flat and shows what a cross section on line C-C of FIG. 3 in the direction of arrows D might then look like. As shown in FIG. 9, the surface 72 of substrate 40 is curved and the turns of coil 42 lie at one region on the surface 72 whilst the turns of coil 44 lie at another region on the surface 72, and it is apparent that the turns of the coils 42 and 44 do not lie in a common plane.

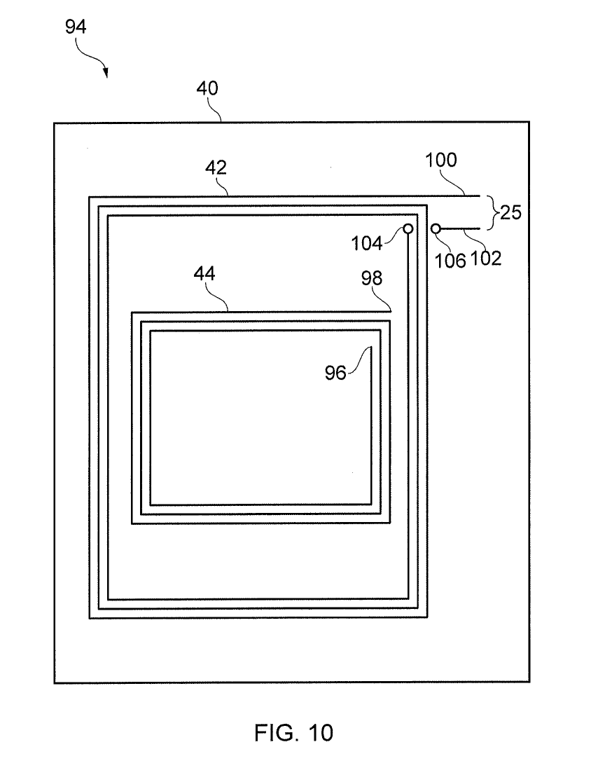

In the embodiments discussed thus far, the outer coil 42 is open-circuited and the inner coil 44 is connected to the modulator 14 and the demodulator 16. However, enhanced performance of the antenna structure 20 arises even if the roles of the coils 42 and 44 are reversed. FIG. 10 shows a variant 94 of the antenna structure 20 in which this reversal has been implemented. As shown in FIG. 10, the ends 96 and 98 of coil 44 are left open-circuited, whereas the ends 100 and 102 of coil 42 provide the connection 25 to the rest of the NFC transceiver 10. The inner turn of coil 42 is connected to end 102 through vias 104 and 106 that allow the intervening turns of coil 42 to be bridged.

1. A wireless communications device comprising an antenna comprising a first coil that is open-circuited and a second coil, wherein one of the first and second coils is nested inside the other one of the first and second coils and wherein the device further comprises at least one of a demodulator coupled to the second coil and arranged to demodulate data from NFC signals picked up by the second coil and a modulator coupled to the second coil and arranged to modulate data onto NFC signals and then supply said signals for the second coil to transmit.

2. A wireless communications device according to claim 1, wherein the first coil is a conductor formed into a spiral having one or more turns and the one or more turns lie on a surface.

3. A wireless communications device according to claim 2, wherein the surface is planar.

4. A wireless communications device according to claim 2, wherein the surface is notional.

5. A wireless communications device according to claim 2, further comprising a substrate that provides said surface.

6. A wireless communications device according to claim 2, wherein the spiral is rectangular.

7. A wireless communications device according to claim 1, wherein the second coil is a conductor formed into a spiral having one or more turns and the one or more turns lie on a surface.

8. A wireless communications device according to claim 7, wherein the surface is planar.

9. A wireless communications device according to claim 7, wherein the surface is planar.

10. A wireless communications device according to claim 7, further comprising a substrate that provides said surface.

11. A wireless communications device according to claim 7, wherein the spiral is rectangular.

12. A wireless communications device according to claim 1, wherein the first coil is nested inside the second coil.

13. A wireless communications device according to claim 1, wherein the second coil is nested inside the first coil.

14. A wireless communications device according to claim 1, wherein the first and second coils are concentric.

15. A wireless communications device according to claim 1, wherein the first and second coils lie on a common surface.

16. A wireless communications device according to claim 15, wherein the common surface is notional.

17. A wireless communications device according to claim 15, wherein the common surface is a plane.

18. A wireless communications device according to claim 15, further comprising a substrate which provides the common surface.
